(19) United States
(12) Patent Application Publication
(10) Pub. No.: US 2013/0046800 A1
(43) Pub. Date: Feb. 21, 2013

(54) Systems for Distributed Secure Storage of Personal Data, In Particular Biometric Impressions, and System, Local Device, and Method for Monitoring Identity

(71) Applicants: Anthony Assi, Paris (FR); Olivier Bettan, Velizy Cedex (FR)

(72) Inventors: Anthony Assi, Paris (FR); Olivier Bettan, Velizy Cedex (FR)

(73) Assignee: THALES, Neuilly-sur-Seine (FR)

(21) Appl. No.: 13/513,195

(22) PCT Filed: Dec. 3, 2010
(86) PCT No.: PCT/EP2010/068897

§ 371 Date: Aug. 6, 2012

(30) Foreign Application Priority Data
Dec. 4, 2009 (FR) 09 05867

(51) Int. Cl. G06F 17/30

(52) U.S. Cl. 707/812; 707/E17.044

(57) ABSTRACT

A system for distributed secure storage of personal data, notably biometric data, a secure identity monitoring system and a local monitoring device, and a secure identity monitoring method. The personal data of persons, notably biometric impressions, are stored beforehand in a central database. The monitoring method includes: a preliminary step of constituting a database of derived data obtained from original personal data by means of a derivation function; a step of acquisition of data for the person; a step of application of the derivation function to said acquired data; a step of comparison of the result of the derivation function with all of the derived data from the database.

The present invention concerns a system for distributed secure storage of personal data, notably biometric data. It also concerns a secure identity monitoring system and a local monitoring device. It finally concerns a secure identity monitoring method.

The invention applies for example to decentralized biometric verification systems while guaranteeing the confidentiality of individual data items.

Biometric methods employ measurement systems that enable automatic identification of persons notably on the basis of their physiological characteristics such as fingerprints, iris or retina of the eyes, for example.

The use of biometrics implies the creation of biometric impression references in order to compare them with fresh data. These biometric impressions may notably be fingerprints, retinal or facial impressions.

When designing a biometric measurement system, the following constraints must be taken into account:
the confidentiality of the personal data such as the impressions in order to protect the persons;
the obligation to have access to the whole of the biometric reference database in order to effect efficacious monitoring operations.

Monitoring and verification operations are effected in a decentralized manner and on a multitude of potential sites, notably passport control infrastructures, identity card control infrastructures and infrastructures controlling access to critical sites. This decentralized management of access to the personal data of persons considerably increases the risk of the confidentiality of that data being compromised.

An object of the invention is notably to enable these constraints to be met at the same time as guaranteeing a high level of confidentiality of the personal data.

To this end, the invention consists in a system for distributed storage of individual data items liable to be used for identity monitoring operations, the system including at least:
a central database storing the original data;
a database storing derivation functions Fi of the original data;
a management unit that effects the calculation of the derived data from the original data by means of the derivation functions and that circulates derived data and derivation functions to verification entities, each verification entity having its own derivation function;
one or more decentralized local databases in the verification entities, said local databases storing the derived data, the stored derived data being liable to be compared with freshly acquired data in the verification entity in which it is situated to which the derivation function Fi specific to that entity has been applied.

The management unit effects for each verification entity, for example:
the selection of the derivation function Fi specific to that verification entity in the database of derivation functions;
the of the derived data from the original data using this derivation function Fi;
the sending of the calculated derived data and the derivation function to the verification entity, the derived data being stored in the local database of the entity.

The management unit sends new derived data and a new derivation function Fi to the verification entity at given time intervals, for example.

The data may advantageously relate to biometric impressions.

The invention also consists in a system for monitoring the identity of persons, the system including a storage system as described above and further including monitoring means assigned in each verification entity, each monitoring means being adapted to effect:
the acquisition of fresh data obtained for a person;
the application of the derivation function Fi specific to the verification entity (3) to this fresh data;
the comparison of the result of the derivation function with all of the derived data stored in the local database of the verification entity.

The invention further consists in a device for local monitoring of the identity of persons, including at least:
a local database of a storage system as described above, said database storing derived data obtained by the application of a derivation function Fi to original personal data, said derivation function being specific to said device;
a memory storing said derivation function Fi;
monitoring means adapted to effect:
   the acquisition of fresh data obtained for a person;
   the application of the derivation function Fi to this fresh data;
   the comparison of the result of the derivation function with all of the derived data stored in the local database.

The derived data is calculated externally of said device, for example, the original personal data being external to said device, this data may relate to biometric impressions.

The invention further consists in a method of monitoring the identity of a person on the basis of personal data previously stored in a database, the method including:
a preliminary step of constituting a database of derived data obtained from original personal data by means of a derivation function Fi;
a step of acquisition of data for the person;
a step of application of the derivation function Fi to said acquired data;
a step of comparison of the result of the derivation function with all of the derived data from the database.

The personal data comprises biometric impressions, for example.

The comparison may employ a biometric test thresholding function.

Other features and advantages of the invention will become apparent in the light of the following description, which is given with reference to the appended drawings, in which:

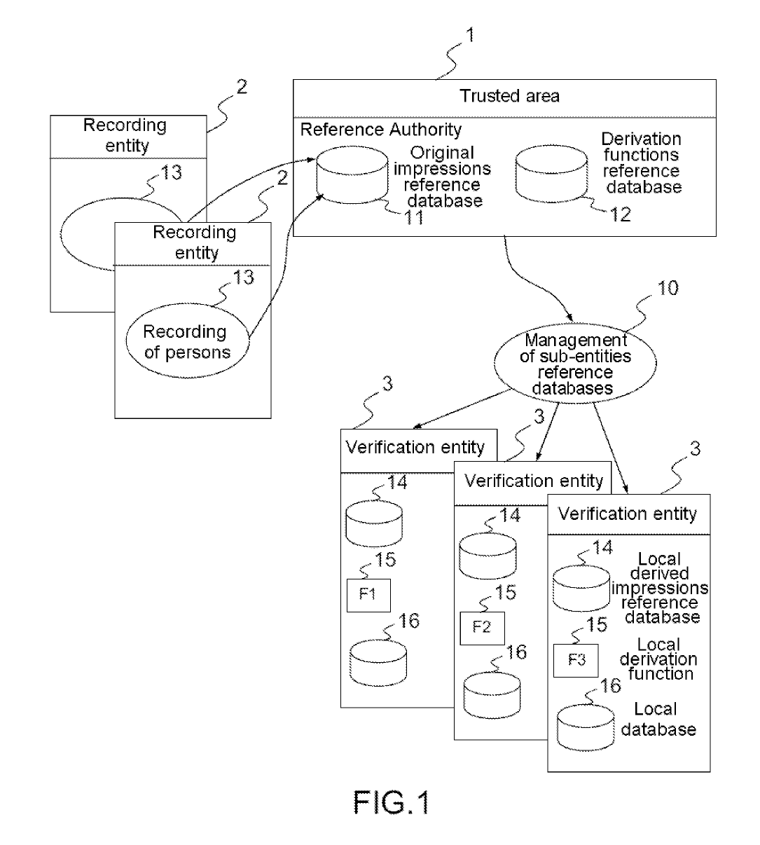

FIG. 1 shows one example of an architecture of a system of the invention;

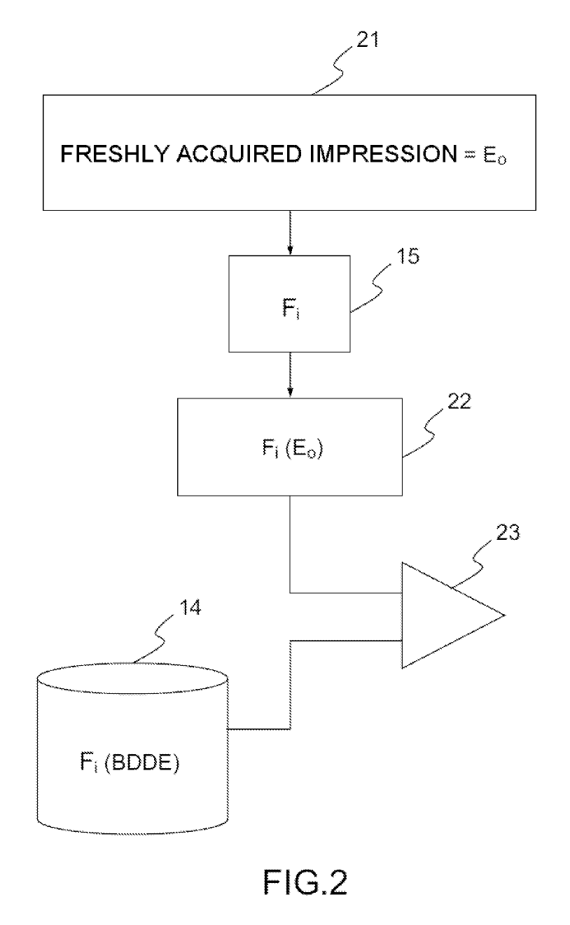

FIG. 2 shows one example of impressions processing at the level of a local verification entity;

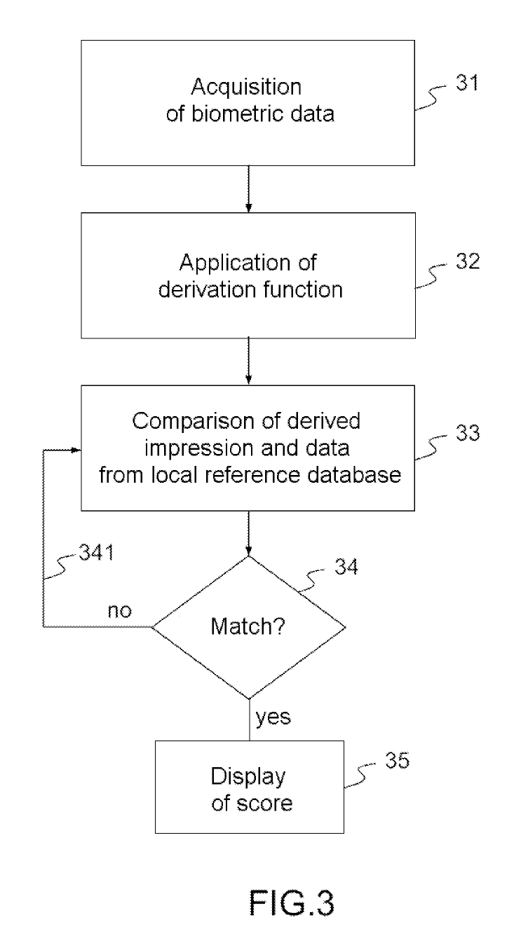

FIG. 3 shows possible steps for monitoring a person by the method of the invention.

FIG. 1 shows one example of an architecture of a system of the invention. The invention uses a secure trusted area 1 for the confidential storage of impressions. This trusted area hosts a first database 11 storing biometric impressions in the raw format. This database 11 includes the original impressions, is unique, and is not shared with the user entities described hereinafter. This assures the confidentiality of the personal data. The trusted area 1 may for example be a white room or any other type of secure room or building.

The trusted area hosts a second database 12 storing derivation functions for the original impressions stored in the first database 11. These derivation functions F1, F2, F3, . . . Fn are transmitted to the user entities. The second database 12 may be referred to hereinafter as the derivation function reference database.

The first database 11 thus contains original impressions each characterizing a person. The content of this first database 11, which will be referred to hereinafter as the original impressions reference database, is composed of recordings of impressions of persons taken over time. Accordingly, recording entities 2 distributed over a given territory send the original impressions reference database 11 the recordings 13 of impressions that they effect on persons.

The system as a whole thus includes one or more trusted recording entities 2 responsible for acquisition and for populating the original biometric impressions database 11 in the raw format. The biometric impressions reference database 11 is thus populated notably by the recording entities 2, which capture the biometric data of persons and all complementary personal data.

The user entities 3 are notably verification entities. These verification entities are for example situated in airports, train stations, exhibition halls and more generally in all public places where it is necessary for security reasons to verify the identity of persons.

Each verification entity 3 includes at least:
a database 14 containing the local references composed in a format derived from the original impressions; each database 14 may be referred to hereinafter as a derived impressions local reference database;
a memory or storage area 15, storing a derivation function that is specific to it, this derivation function F1, F2, . . . Fn being obtained from the derivation function reference database 12 placed in the trusted area 1.

Each verification entity may further include a local database 16 containing biometric impressions recorded locally. These may for example be transmitted to the reference authority to feed the original impressions reference database like the recording entities 2.

The trusted area 1 includes a reference unit 10, or management unit 10 for the local reference database 14, which converts and circulates the original impressions in derived formats specific to each verification entity. This unit 10 is for example implemented in a computer interfaced to the databases 11, 12.

A function Fi from the derivation functions reference database is assigned to each verification entity 3. The management unit 10 calculates from the function Fi the image of the biometric impressions stored in the original impressions reference database 11.

Accordingly, if {BDDE} denotes all of the original impressions stored in the first database 11, the management unit 10 calculates the image of each of these impressions using the function Fi to form the set of original impressions images by this function Fi, denoted {Fi(BDDE)}, transmitted to the corresponding verification entity and stored in its local reference database 14. Thus the set Di of derived impressions images is defined as follows:

Di={Fi(BDDE)} (1)

In the FIG. 1 example, three verification entities 3 are represented:
a first entity is assigned a first function F1, the derived impressions local reference database 14 then including the set of images {F1(BDDE)};
a second entity is assigned a second function F2, the derived impressions local reference database 14 then including the set of images {F2(BDDE)};
a third entity is assigned a third function F3, the derived impressions local reference database 14 then including the set of images {F3(BDDE)}.

These local reference databases include images that are derived from the original impressions and that are therefore distorted. An image distorted in this way does not allow its original impression to be reconstituted. This assures data confidentiality. The stored impressions images must nevertheless allow reliable comparison with the derivative of a freshly acquired impression.

The derivation functions F1, F2, F3, . . . Fn may advantageously be modified regularly, which makes the system as a whole more secure.

FIG. 2 shows an example of processing derived impressions at the level of a verification entity.

A person goes to a monitoring station that takes a biometric impression 21 of them corresponding for example to a physiological characteristic of the person such as for example a fingerprint, an image of the iris or an image of the retina of the eyes. This freshly acquired impression, denoted E₀ hereinafter, is processed by a calculation unit 15, that applies the function Fᵢ to it, this function Fᵢ being the derivation function specific to the verification entity in which the person is located. The calculation unit then delivers the derived impression 22, or distorted image, denoted E_{D} and defined as follows:

E_{D}=Fi(E₀) (2)

This derived impression E_{D} is then compared with the derived impressions stored in the local reference database 14 storing the whole of the image of the derived impressions obtained by the same function Fᵢ from the set of original impressions {BDDE} stored in the reference database 11 of the verification entity. The comparison means 23 are for example integrated into the calculator unit that generates the derived impression.

Access to all of the impressions is thus assured at the level of each verification center 3, but in a derived, and thus distorted, form that is nevertheless sufficient to make comparisons and to detect persons. Because of this, to verify an impression, the verification entities merely need their derived impressions local reference database 14, which does not contain confidential data, usable only in their environment.

FIG. 3 shows the possible steps of an operation of monitoring a person, corresponding for example to FIG. 2.

In a first step 31, biometric data of the person forming their impression is acquired.

In a second step 32, the derivation function Fi is applied to the sampled biometric impression. This function Fi is specific to the verification entity.

In a third step 33, the derived impression is compared with the derived impressions stored in the local reference database 14, these impressions being derived from the original impressions using the same function Fi. The function Fi is such that it does not degrade the classic biometric test functions. In other words, the classic biometric tests may be applied to the derived impressions like they are applied to the original impressions without degrading the conditions or the results of the test. In these classic tests, the results of comparing a freshly acquired impression and a reference impression are obtained as a function of a threshold. The comparison step 33 includes a thresholding function. It therefore employs thresholds, which may be adjusted to the same level as the thresholds applied to non-derived impressions. If the result of the comparison 33 is below a given threshold, there is deemed to be no match 34 between the freshly acquired derived impression and the stored derived impression used for the comparison. In this case, the freshly acquired derived impression is compared 341 with another derived impression stored in the local database 14. The comparison may be extended with the data stored in the local database 16 that stores the impressions recorded locally. In this case, the derivation function Fi is also applied to the impressions of this local database 16.

If the threshold is exceeded, the score is displayed 35. The monitored person may be made to coincide with a derived impression stored in the local reference database 14. It is then possible to retrieve the original impression on application to the reference authority that monitors the trusted area, and thus the reference database of original impressions and derivation functions.

The invention can thus be implemented by installing an infrastructure conforming to an architecture including an authority 1 responsible for:
unique and secure storage 11 of the biometric impressions;
storage 12 of the derivation functions specific to the verification entities 3;
updating, i.e. adding, modifying or deleting, the local reference databases 14 of the verification entities.

The authority 1 updates the local databases of all the verification entities that it trusts by the following steps:
selection of the derivation function specific to the verification entity;
calculation of the derived impressions using that function;
sending the result to the entity.

In this architecture, each verification entity 3:
has access to a local reference database 14 containing a derived format of the biometric impressions;
has access to a derivation function 15 specific to it;
is responsible for the verification of derived biometric impressions in its local reference database.

The entity 3 wishing to verify an impression applies the following steps, for example:
acquisition of a fresh impression;
application of the derivation function to that impression;
comparison of the result with the derived impressions stored in the local database of the entity.

The invention notably has the following advantages:
corruption of a verification entity 3 does not imperil the confidentiality of the personal biometric information;
compromising a verification entity has no impact on its perimeter because the local information, constituted notably of the derived impressions reference database 14 and the derivation function Fi, 15, are different from one verification entity to another;
preservation of the original impressions is not delegated to the verification entities, only one authority 1 having access to them;
the verification entities 3 and recording entities 2 may be hosted outside the trusted area;
administration operations such as creation, generation of derived impressions local database, derivation function changing and updating are centralized with the reference authority, more particularly at the level of the management unit 10;
in the event of disaster of a user entity 2, 3.

1. A system for distributed storage of individual data items liable to be used for identity monitoring operations, said system comprising:
a central database storing the original data;
a database storing derivation functions of the original data;
a management unit that effects the calculation of the derived data from the original data by means of the derivation functions and that circulates derived data and derivation functions to verification entities, each verification entity having its own derivation function; and
one or more decentralized local databases in the verification entities, said local databases storing the derived data, the stored derived data being liable to be compared with freshly acquired data in the verification entity in which it is situated to which the derivation function specific to that entity has been applied.

2. The storage system as claimed in claim 1, wherein the management unit effects for each verification entity:
selection of the derivation function (Fi) specific to that verification entity (3) in the database (12) of derivation functions;
calculation of the derived data from the original data using this derivation function; and
sending of the calculated derived data and the derivation function to the verification entity, the derived data being stored in the local database of the entity.

3. The storage system as claimed in claim 2, wherein the management unit sends new derived data and a new derivation function to the verification entity at given time intervals.

4. The storage system as claimed in claim 1, wherein the data relates to biometric impressions.

5. A system for monitoring the identity of persons, said system comprising:
a storage system as claimed in claim 1; and
monitoring means assigned in each verification entity of the storage system, each monitoring means being adapted to effect:
acquisition of fresh data obtained for a person;
application of the derivation function specific to the verification entity to this fresh data; and
comparison of the result of the derivation function with all of the derived data stored in the local database of the verification entity.

6. A device for local monitoring of the identity of persons, the device comprising:
a local database of a storage system as claimed in claim 1, said database storing derived data obtained by the application of a derivation function to original personal data, said derivation function being specific to said device;
a memory storing said derivation function; and
monitoring means adapted to effect:
acquisition of fresh data obtained for a person;
application of the derivation function to this fresh data; and
comparison of the result of the derivation function with all of the derived data stored in the local database.

7. The device as claimed in claim 6, wherein the derived data is calculated externally of said device; the original personal data being external to said device.

8. The device as claimed in claim 6, wherein the data relates to biometric impressions.

9. A method of monitoring the identity of a person on the basis of personal data previously stored in a database, the method comprising:
a preliminary step of constituting a database of derived data obtained from original personal data by means of a derivation function;
a step of acquisition of data for the person;
a step of application of the derivation function to said acquired data; and
a step of comparison of the result of the derivation function with all of the derived data from the database.

10. The method as claimed in claim 9, wherein the personal data comprises biometric impressions.

11. The method as claimed in claim 10, wherein the comparison employs a biometric test thresholding function.
